(19) United States
(12) Patent Application Publication
(10) Pub. No.: US 2017/0128965 A1
(43) Pub. Date: May 11, 2017

(54) MODULAR COATING UNIT AND METHOD FOR COATING PLASTIC COMPONENTS

(71) Applicant: Magna Exteriors GmbH, Sailauf (DE)

(72) Inventor: Johannes GÖTZELMANN, Altertheim (DE)

(21) Appl. No.: 15/344,718

(22) Filed: Nov. 7, 2016

(30) Foreign Application Priority Data
Nov. 10, 2015 (DE) 102015222134.2

(51) Int. Cl. B05B 7/26; B01F 3/08; B05D 1/02

(52) U.S. Cl. CPC B05B 7/26; B05D 1/02; B01F 3/088; B01F 2003/0896; B01F 2215/005

(57) ABSTRACT

A method for coating plastic components of a motor vehicle. A modular coating unit is provided having a first coating module for coating at least one workpiece composed of plastic. A second module for the preparation of the coating material may be provided in the coating unit. The completed coating material to be applied is mixed from a base material composed of non-volatile components from a first container, to which solvent or water from a second container and concentrated colour pigments and/or effect pigments from third containers may be admixed in the module for the preparation of the coating materials.

### CROSS-REFERENCE TO RELATED APPLICATIONS

The present application claims priority 35 U.S.C. §119 to German Patent Publication No. DE 10 2015 222 134.2 (filed on Nov. 10, 2015), which is hereby incorporated by reference in its entirety.

### TECHNICAL FIELD

Embodiments relate to a method for coating plastic components, and a modular coating unit having at least one module as coating module for coating at least one workpiece of plastic, and a mixer. At least one module for the preparation of the one-component coating materials for the coating is present in the coating unit. The completed coating material to be applied is mixed from a base material composed of non-volatile components from a first container, to which solvent or water from a second container and concentrated colour pigments and/or effect pigments from third containers may be admixed in the module for the preparation of the coating materials.

### BACKGROUND

Alongside the shape and the technical details, a flawless finish is an important aspect in the purchase of a vehicle. The paint finish is to be immaculate and has a lot to perform, from protecting the bodywork from corrosion through to providing protection from mechanical and harmful weathering effects. In OEM finishing, a variety of technologies are employed, and it is only the interplay of these technologies that perfects an automotive finish and results in the bodywork being ideally protected, having a glossy appearance, and making a long-term contribution to the retention of value on the part of the vehicle.

Generally speaking, conventionally, an OEM automotive finish uses four coats, which are applied in a number of operations, and using different techniques. First, the degreased and cleaned bodywork is provided with an impervious coating film, extending into every cavity, by way of an electrochemical coating system. This cathodic deposition coating, or cathodic electrocoat, is the basis for comprehensive corrosion protection. In this procedure, the cathodic, i.e., negatively charged, bodywork is passed through an aqueous, conductive deposition coating material, in which the positively charged coating-material particles adhere to the bodywork and form an impervious and uniform coating.

This is followed by application of the primer-surfacer, which has a number of functions to fulfil at one and the same time. As well as protecting against stone chipping, it compensates minor unevennesses on the surface, filling them out, so to speak. Moreover, it ensures that the subsequent topcoat is able to adhere more effectively.

Only then does the bodywork acquire its colour, in the form of the basecoat. In the car plants, robotic coaters spray the entire bodywork in the up-to-date shades. These coating systems, which are nowadays water-based, may comprise effect pigments or, as in the case of a metallic finish, aluminium flakes. The final step is the spray application of a colourless clearcoat. The function of the clearcoat is to protect the colour-imparting coating from external influences, such as UV radiation, organic or chemical soiling or other forms of damage.

With these four steps, the finishing of the bodywork is complete. Only at this point are accessory components such as exterior mirrors or bumpers mounted, both on the exterior and inside. These components usually comprise plastic and are coated separately. In spite of the differences in substrates and in production conditions, the shades must be an exact match with those of the bodywork.

In coating lines for plastic components for the automotive industry, in the basecoat material, coating materials are used that are prefabricated mixtures from paint suppliers, the coating materials being mixed according to the stipulations of the coating line and also those of the raw materials manufacturer and of the end customer, at the manufacturer's premises. Harmonization in the case of new production runs is performed directly according to specimen colour standards and coating line requirements, and is consequently very involved and costly, since in each case the batch productions carried out are relatively small and there is a wide pallet of colours that must be prepared and held in stock.

In the case of batch production of small and very small quantities, the result of this is a very high level of warehousing of containers of different sizes in different coating materials. The coating materials take the form of completed mixtures, and there is no possibility for adaptation, after the approved colour standard has been received, and no possibilities for adjustment in the event of minor deviations in shade. For the supplier of the plastic parts, which are to be supplied in coated form, therefore, the problem is that all colours from all customers must be held in stock and, in the event of problems, an approach must always be made to the paint supplier.

Known from German Patent Publication No. DE 10 2008 053 178 A1 is a coating method wherein base paints are to be mixed in the spray mist and/or on the coated surface to give the end result. This, however, is done using paint preparations which are already fully premixed. The mixing together of paints from the base paints is not an easy operation and is not employed in this form in practice.

As illustrated in FIG. 1, a conventional coating line of the kind used, for example, for the coating of exterior components in auto manufacturing. Initially, it is immaterial whether metal components or components of plastic are being coated. The coating line has a coating module, and comprises primarily of a coating apparatus 11, which, via a robotic device or a fixed installation, is to spray a coating mist 10 over a workpiece 4. The coating apparatus 11 here is a spray gun on a robotic arm, or a spraying head of a coating bridge. Of course, one module is illustrated only by way of example. It is possible for a multitude of coating modules to be used, in parallel or in series.

The coating material which is sprayed by the spray gun or the coating bridge is taken via containers 5 for coating materials. These containers contain completed coating materials which are supplied in completely mixed form as prepared at the premises of the coating manufacturer. The coating apparatus can be connected to all containers 5 for the coating material to be used. If, for example, bumpers are being coated, the respective paints from the respective containers are used and are switched after each group or else after individual workpieces. The coating materials here are provided in ready-mixed form by the manufacturer.

As a result, large volumes of stocked completed coating materials are present, since each customer requires its own red, its own black, etc.

### SUMMARY

Embodiments relate to providing an inexpensive process of coating of plastic components having relatively flexible facilities for adjustment and intervention in the area of paint processing, and also in the area of the shade of the coating materials.

In accordance with embodiments, independent mixing and formulation of different components in situ on a coating line is used to form a completed coating mixture.

In accordance with embodiments, a modular coating unit has a mixer and at least one module comprising a coating module for coating at least one workpiece of plastic. The at least one module for the preparation of the coating materials for coating is present in the coating unit. The completed coating material for application is mixed from a base material composed of non-volatile components from a first container, to which solvent or water from a second container, and concentrated colour pigments and/or effect pigments from third containers may be admixed in the module for the preparation of the coating materials.

Advantageously, the completed coating material is based on a base material which can be produced very favourably and is transport-friendly in having a small volume. Moreover, the further properties, such as the final shade, are only formed by admixing, and thus, are harmonized by the coater itself in situ. The late admixing of the solvent or water also simplifies the handling of the material and, especially when water is used, achieves an overall reduction in the transport volume.

Advantageously, the completed coating material comprises a base material from a first container and solvent or water (L) from a second container in a quantitative volume fraction of at least 80%. Hence, it is possible to use a very favourable base material from the coating-material manufacturer, which can be the same across different shades or properties of the completed coating material. The final, eventual harmonization is then achieved via the admixing of solvent or water and of concentrated colour pigments and/or effect pigments in the coating unit. This produces a number of advantages, which lie above all in an optimization of costs, but also in processing advantages, since possibilities for intervention by the processor in the coating line itself are expanded.

Advantageously, an advantage may me derived if the mixer accesses the first container for the base material, accesses second containers with solvent or water, and accesses the respective third containers for concentrated colour pigments and/or effect pigments.

Advantageously, the mixture is in communication with the coating apparatus, and it is also possible for the mixer to be integrated in the coating apparatus.

In accordance with the method for the coating of plastic components with a modular coating unit, the completed coating material used is mixed in situ in the coating unit from a base material, solvent or water and concentrated colour pigments and/or effect pigments.

Advantageously, the completed coating material is mixed in a mixer in the module for the preparation of the coating materials and is transported as completed coating material to the coating unit. An alternative possibility is for the coating material to be mixed in a mixer in the coating unit.

Even without upstream mixers, it is advantageous if the completed coating material is mixed in the spray mist of the coating unit, with the components being supplied simultaneously in the correct mixing ratio to at least one spraying head. In accordance with embodiments, the spray mist may be considered to be the mixer.

The method in accordance with embodiments has a further advantage in that the coating material is not premixed, the components instead being applied in succession at the correct application time.

Depending on the coating-line design, the various components can be applied even without actual mixing. In accordance with embodiments, there is a kind of preliminary coating with the first robots and/or coating elements, of the favourable basecoat material, and the final shade adjustment takes place at the end, by the application of the concentrate.

Dark shades and multi-coat finishes and metallic applications may be produced more cost-effectively in this way. In the case of metallic finishes, a preliminary coating may take place, for example, without the aluminium or metal flakes, and the expensive component of the metallic finishes is now applied only as a minor, thin coat on the basecoat material.

The coating materials are materials which cure purely through evaporation, in other words one-component systems, not two-component systems with chemical reaction curing.

### DRAWINGS

Embodiments will be illustrated by way of example in the drawings and explained in the description below.

FIG. 1 illustrates a coating line, schematically, in the prior art.

FIG. 2 illustrates a schematic representation of a coating unit, in accordance with embodiments.

FIG. 3 illustrates a schematic representation of a coating unit, in accordance with embodiments.

FIG. 4 illustrates a schematic diagram of the method, in accordance with embodiments.

FIG. 5 illustrates an example of a distribution V of the colour pigments over the thickness d of the coating film, in accordance with embodiments.

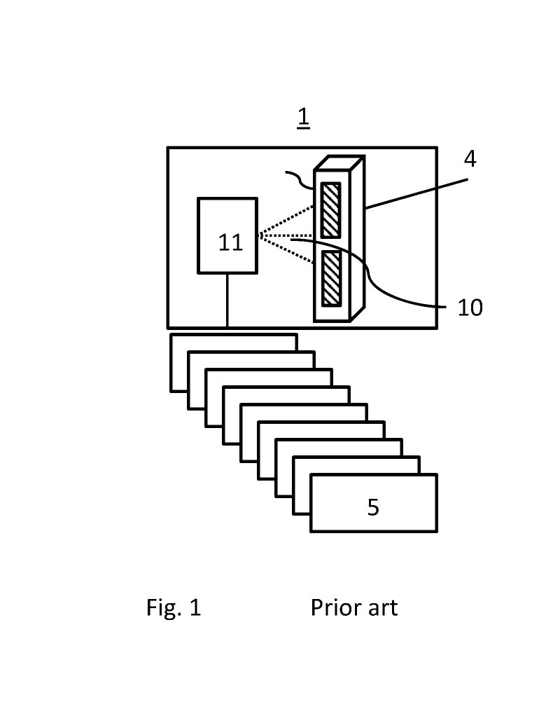

### DESCRIPTION

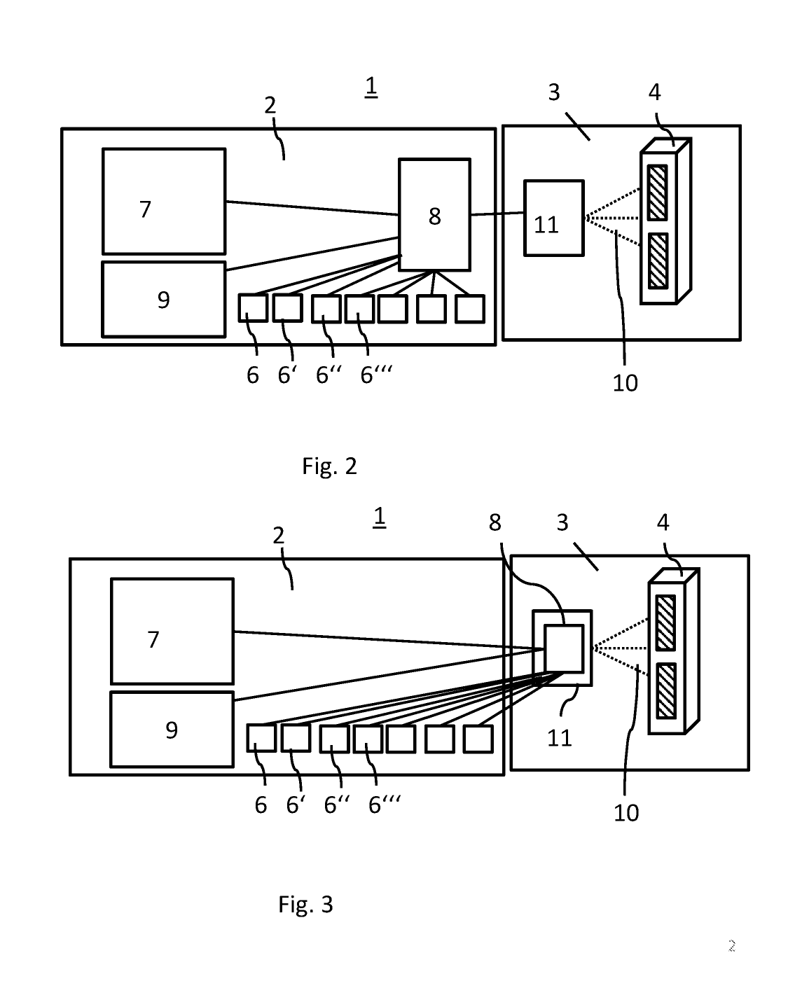

As illustrated in FIG. 2, a modular coating unit 1, provides for, instead of using the coating materials in the form of a completed mixture, a preparation module 2 for the preparation of the coating materials, and a coating module 3 that includes a coating apparatus 11 to spray a mist 10 to provide a coating on a workpiece 4. The workpiece 4 comprises, for example, a plastic component of a motor vehicle. The preparation module 2 includes a mixer 8 operatively or otherwise fluidically connected to a first container 7 for a base material, a second container 9 for solvent or water, and also additional containers 6, 6′, 6″, 6′″ . . . with concentrated colour pigments and/or effect pigments.

In accordance with embodiments, the coating material comprises volatile solvents and non-volatile constituents. The solvent, as the volatile constituent, evaporates during the drying process, while the non-volatile constituents adhere in the form of a smooth film on the coated article. The non-volatile components are binders, pigments, oils, resins, fillers and additives. The binder ensures effective and uniform suspension with pigments and solvent in the coating material, and is responsible for optimum drying and for the gloss after drying. The essential basis for a coating material is the binder and solvent. Pigments are not necessary constituents of a coating material.

For a motor vehicle, around 15 kg of paint is used, as wet weight, resulting in a dry weight of approximately 5 kg. The high proportion of solvent in completed coating materials is evident. By separating the constituents into non-volatile constituents and solvent/water and concentrated colour pigments and/or effect pigments, the handling, the transport and the mixing possibilities of the coating line are optimized.

In accordance with embodiments, the base material in the first container 7 comprises primarily of the non-volatile constituents, without concentrated colour pigments and/or effect pigments and a large percentage of solvent is useful for the further processing of the base material. Located in the second container 9 is the respective solvent; if a water-based coating mixture is being used, a container may also be considered as a water connection. In this case, the handling of the base material is even more efficient, since there is no longer any solvent that must be transported.

The containers 6, 6′, 6″, 6′″ . . . contain paints with a high colour pigment density or else metal particles of the kind required for metallic finishes. In the mixer 8, the components, the base material, solvent, or water and the concentrated colour pigments and/or effect pigments, are mixed to give the desired coating-material outcome, in the form of completed coating material.

An advantage here is a mixing ratio of approximately 80% base material plus solvent/water with 20% concentrated colour pigments and/or effect pigments. Of course it would be desirable to employ as much base material plus solvent as possible, as it is less expensive than the colour pigments. It must, however, always still be possible to admix sufficient colour and/or metal particles, in order to achieve the appropriate perceived colour for the entire colour palette which is to be offered. Optimum ranges are 10-20% base material, 60-70% solvent/water and 10-30% concentrated colour pigments and/or metal pigments.

The completed coating material premixed in the mixer 8 is supplied to the coating apparatus 11, and is applied to the workpiece 4.

As illustrated in FIG. 3, alternatively to an arrangement illustrated in FIG. 2, it is also possible for the mixing function as mixer 8 to be accommodated directly in the coating apparatus 11, near to or directly in the spraying head. In a continuation of this approach, the three components are mixed without a separate mixer directly in the spray mist 10, a possibility which exists as a result of appropriate design of the nozzles. The spray mist, accordingly, functions itself as mixer.

As illustrated in FIG. 5, the lines and methods described so far mix base material plus solvent/water and concentrated colour pigments and/or effect pigments virtually homogeneously over the thickness d of the coating film, as shown in the dashed line.

A further embodiment does not use uniform mixing of the three components in the coating film, but instead constructs the coating film from a mixture of base material plus solvent/water with at least one thin, concentrated colour and/or metal pigment film. This colour film may lie at the surface of the coating film or is integrated into the layers of the base material plus solvent/water.

For this purpose, the base material plus solvent/water is applied first of all and then a thin film of the concentrated colour and also, optionally, a sequence of basecoat material and colour is applied.

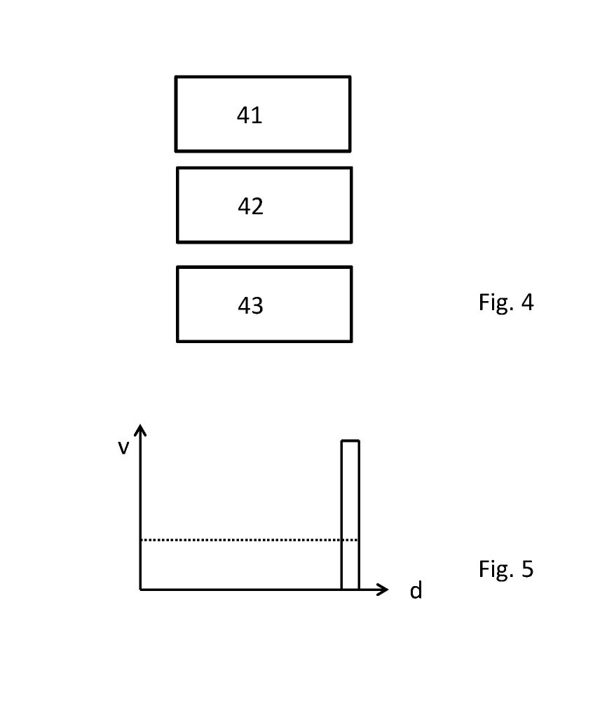

As illustrated in FIG. 4, a method includes in an initial block 41, providing a film of base material plus solvent/water. Block 42 includes admixing a component composed of concentrated colour and/or metal pigment film to the base material plus solvent/water. Block 43 involves applying the mixture. Accordingly, a uniformly coloured coating is provided.

Alternatively, the initial block 41 may include applying a film of base material plus solvent/water, followed by the application of a thin film of fully concentrated colour and/or metal pigments, a procedure which can be repeated as desired.

The result is either a completed coating material mixture, which is maintained homogeneous throughout the coating film, or which extends only to a thin film.

In accordance with embodiments, it is possible to admix paint residues, comprises colour pigments, to a colour mixture in current use in the completed coating material. Accordingly, for example, black colour pigments of one customer can be admixed at least partially to the black colour pigments of another customer, supplied by a different coatings manufacturer. It is therefore possible to recycle material which would otherwise have to be removed or thrown away.

The term “coupled,” or “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application

### LIST OF REFERENCE SYMBOLS

1 modular coating unit
2 module for the preparation of the coating materials
3 coating module
4 workpiece
5 container, coating materials
6 third container, concentrates
7 second container, base material
8 paint mixer
9 second container, solvent
10 coating mist
11 coating apparatus

What is claims is:

1. A modular coating unit, comprising:
at least one module including a coating module for coating at least one workpiece composed of plastic, and a mixer to admix a coating material that includes a base material composed of non-volatile components from a first container, a solvent or water from a second container, and concentrated colour pigments and/or effect pigments from at least one third container.

2. The modular coating unit of claim 1, wherein the base material from the first container and the solvent or water from the second container are present in a quantitative volume fraction of at least 80% in the coating material to be applied.

3. The modular coating unit of claim 1, wherein the coating material to be applied comprises 10-20% base material.

4. The modular coating unit of claim 3, wherein the coating material to be applied comprises 60-70% solvent/water.

5. The modular coating unit of claim 4, wherein the coating material to be applied comprises 10-30% concentrated colour pigments and/or effect pigments.

6. The modular coating unit of claim 5, wherein the effect pigments comprises metal pigments.

7. The modular coating unit of claim 1, wherein the mixer is configured to access the first container, accesses the second container, and access the at least one third container.

8. The modular coating unit of claim 1, wherein the mixer is in fluidic communication with the coating module.

9. The modular coating unit of claim 1, wherein the mixer is integrated in the coating module.

10. A method for coating a plastic component of a motor vehicle, the method comprising:
providing a modular coating unit that includes at least one module including a coating module for coating at least one workpiece composed of plastic, and a mixer to admix a coating material that includes a base material composed of non-volatile components from a first container, a solvent or water from a second container, and concentrated colour pigments and/or effect pigments from at least one third container;
producing a completed coating material by mixing in situ, using the mixer, a base material, a solvent or water, and concentrated colour pigments and/or effect pigments.

11. The method of claim 10, further comprising transporting the completed coating material to the coating module.

12. The method of claim 10, wherein mixing in situ, using the mixer, is conducted in the coating module.

13. The method of claim 10, further comprising mixing the completed coating material in a spray mist of the coating module, and simultaneously supplying the completed coating material in a predetermined mixing ratio to at least one spraying head.

14. The method of claim 10, wherein producing the completed coating material comprises admixing paint residues from the at least one third container.

15. The method of claim 10, wherein producing the completed coating material comprises mixing the base material, the solvent or water, and the concentrated colour pigments and/or effect pigments in the coating unit.

16. The method of claim 15, further comprising supplying, in a predetermined mixing ratio, the base material, the solvent or water, and the concentrated colour pigments and/or effect pigments to at least one spraying head.
